(19) United States
(12) Patent Application Publication
(10) Pub. No.: US 2013/0093327 A1
(43) Pub. Date: Apr. 18, 2013

(54) CONTROL METHODS FOR LED CHAINS

(71) Applicant: Leadtrend Technology Corp., Hsin-Chu (TW)

(72) Inventor: Ching-Tsan Lee, Hsin-Chu (TW)

(73) Assignee: LEADTREND TECHNOLOGY CORP., Hsin-Chu (TW)

(21) Appl. No.: 13/650,135

(22) Filed: Oct. 12, 2012

(30) Foreign Application Priority Data
Oct. 13, 2011 (TW) 100137070

(51) Int. Cl. H05B 37/03

(52) U.S. Cl. 315/122

(57) ABSTRACT

Control methods for driving LED chains. An output power is provided to drive the LED chains. Short protections are provided to the LED chains, respectively. Whether at least one of the LED chains encounters an under-current event is detected. If any one of the LED chains encounters the under-current event, all short protections are stopped. Whether the output power reaches safe requirement is detected. After the output power reaches the safe requirement, the short protection corresponding to a normal LED chain is resumed. The normal LED chain refers to one of the LED chains that does not encounter the under-current event.

### BACKGROUND OF THE INVENTION

1. Field of the Invention

The present invention relates to control methods and control circuits for light-emitting diode (LED) chains, and particularly to a control method for performing short protection in LED chains.

2. Description of the Prior Art

In an age concerned with energy conservation and carbon reduction, light-emitting diodes (LEDs) are already a widely adopted light source due to their superior lighting efficiency and miniature component size. For example, LEDs have already replaced cold-cathode fluorescent lamps (CCFLs) as a backlight in current liquid crystal display (LCD) panels.

FIG. 1 is a diagram illustrating an LED power supply 18 used in a backlight module of an LCD panel, which is primarily used to control lighting of LED chains L₁-L_{N}. Each LED chain has a plurality of series-connected LEDs. Backlight controller 20 controls a power switch of booster 19 to cause an inductive element to draw energy from input node IN, and release energy into output node OUT, so as to establish an appropriate output voltage V_{OUT} on output node OUT to drive the LED chains. Backlight controller 20 detects output voltage V_{OUT} through over-voltage protection node OVP and voltage divider resistors RD₁, RD₂.

Backlight controller 20 simultaneously causes current flowing through each LED chain to be approximately equal to achieve the goal of uniform brightness. Current sensing resistors RS₁-RS_{N} respectively detect driving currents flowing through LED chains L₁-L_{N}, and detection results are sent to backlight controller 20 through current detection nodes CS₁-CS_{N}. Backlight controller 20 controls impedance of NMOS transistors N₁-N_{N} based thereon, so as to make driving currents approximately equal.

Feedback nodes FB₁-FB_{N} of backlight controller 20 roughly detect cathodes D₁-D_{N} of LED chains L₁-L_{N} through resistors R₁-R_{N}. From information received by feedback nodes FB₁-FB_{N}, backlight controller 20 may cause booster 19 to operate in a more efficient state. Further, backlight controller 20 may also determine whether any LED encounters an open- or short-circuit problem from feedback nodes FB₁-FB_{N}, so as to trigger corresponding open-circuit protection or short protection. For example, if feedback voltage V_{FB-1} on feedback node FB₁ is constantly a 0 voltage, LED chain L₁ may be an open-circuited LED chain, where at least one LED thereof is open-circuited, so that backlight controller 20 turns off driving of LED chain L₁. In another example, if feedback voltage V_{FB-2} on feedback node FB₂ is much greater than feedback voltage V_{FB-1} on feedback node FB₁, short protection of backlight controller 20 may determine that LED chain L₂ has some LEDs that are short-circuited, and thus turn off driving of LED chain L₂.

However, open protection and short protection may interfere with each other, so that an appropriate length sequence for activating or disabling open protection and short protection is needed to realize the actual protection effect desired.

### SUMMARY OF THE INVENTION

According to an embodiment, a control method for driving light emission of a plurality of light-emitting diode (LED) chains comprises detecting the LED chains to regulate an output power, wherein the output power is used for driving the LED chains; controlling a plurality of driving currents flowing respectively through the LED chains; detecting whether at least one of the driving currents encounters an under-current event, wherein an open-circuited LED chain is an LED chain encountering the under-current event, and a normal LED chain is an LED chain not encountering the under-current event; stopping short protections applied to the LED chains when the under-current event is encountered; detecting whether the output power encounters an over-voltage event; stopping regulating of the output power when the over-voltage event is encountered; detecting whether the output power returns to a safe level; and resuming regulation of the output power and resuming the short protections applied to the normal LED chain after the output power returns to the safe level.

According to an embodiment, a control method for driving light emission of a plurality of LED chains comprises driving the LED chains by an output power; providing short protection corresponding to each of the LED chains; detecting whether the LED chains encounter an under-current event; stopping the short protections of all of the LED chains if any one of the LED chains encounters the under-current event; detecting whether the output power reaches a safe level; and resuming short protection corresponding to a normal LED chain after the output power reaches the safe level. The normal LED chain has not encountered the under-current event.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an LED power supply used in a backlight module of an LCD panel.

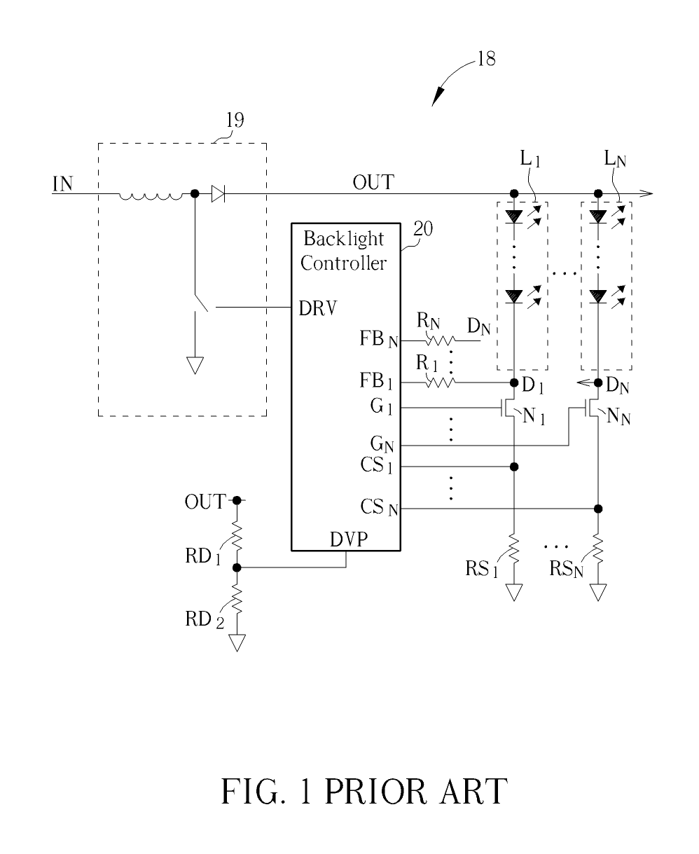

FIG. 2 is a diagram of backlight controller according to an embodiment.

FIG. 3 is a diagram illustrating a control method according to an embodiment.

FIG. 4 illustrates waveforms of signals of FIG. 2 during operation of control method of FIG. 3.

### DETAILED DESCRIPTION

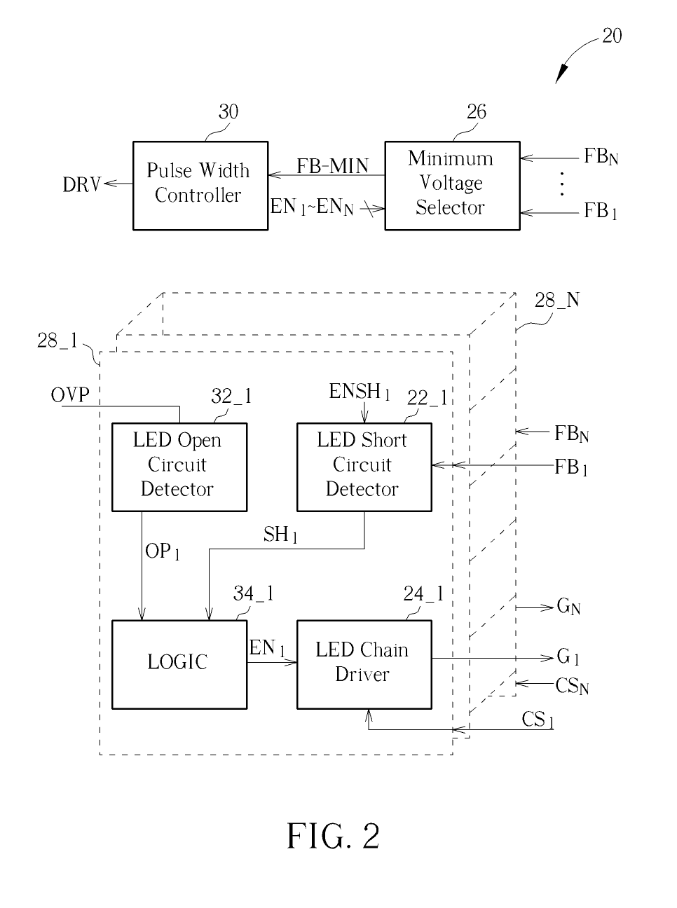

FIG. 2 is a diagram of backlight controller 20 according to an embodiment. Backlight controller 20 controls NMOS transistors N₁-N_{N} through gates G₁-G_{N}. Driving current flowing through NMOS transistors N₁-N_{N} can be sensed roughly from current sense nodes CS₁-CS_{N}. Backlight controller 20 also controls power switch of booster 19 from driving node DRV to cause inductor thereof to charge or discharge. In some embodiments, backlight controller 20 is a monolithic integrated circuit.

As shown in FIG. 2, backlight controller 20 comprises pulse width controller 30, minimum voltage selector 26, and a plurality of driving modules 28₁-28_{N}.

Minimum voltage selector 26 may generate minimum feedback voltage V_{FB-MIN} on minimum feedback node FB-MIN according to the minimum value of feedback voltages V_{FB-1}-V_{FB-N} on feedback nodes FB₁-FB_{N}. Pulse width controller 30 controls power switch of booster 19 from driving node DRV to cause voltage V_{OUT} on output node OUT to increase or decrease, so as to hold minimum feedback voltage V_{FB-MIN} at roughly a preset feedback value. In this way, operation of NMOS transistors N₁-N_{N} can be made more efficient. For example, pulse width controller 30 controls minimum feedback voltage V_{FB-MIN} to approximately 1V, and the minimum value of feedback voltages V_{FB-1}-V_{FB-N} can be approximately 1V.

Driving modules 28₁-28_{N} respectively correspond to LED chains L₁-L_{N}. Driving modules 28₁-28_{N} may have the same or similar circuitry, architecture, or function. The following description takes driving module 28₁ as an example. Those of ordinary skill in the art would be able to derive or realize internal architecture, interconnections, and functions of other driving modules 28₂-28_{N} according to the description of driving module 28₁.

Driving module 28₁ comprises LED short detector 22₁, LED open circuit detector 32₁, logic circuit 34₁, and LED chain driver 24₁.

When enable signal EN₁ is enabled, LED chain L₁ should be lit, LED chain driver 24₁ causes driving current flowing to be roughly equal to a preset value through LED chain L₁ through gate G₁ and current sense node CS₁. When enable signal EN₁ is disabled, LED chain driver 24₁ keeps NMOS transistor N₁ turned off through gate G₁, exhibiting an open-circuited state, and causing LED chain L₁ not to be lit. Simultaneously, disabled enable signal EN₁ also causes minimum feedback voltage V_{FB-MIN} not to be affected by feedback voltage V_{FB-1} on feedback node FB₁. In other words, disabled enable signal EN₁ isolates minimum feedback voltage V_{FB-MIN} from feedback node FB₁.

LED short detector 22₁ is coupled to feedback node FB₁, and when short protection enable signal ENSH₁ is enabled, determines whether LED chain L₁ encounters an LED short event according thereto to provide related protection mechanisms. In some embodiments, when feedback voltage V_{FB-1} is clamped to 5V, and if current I_{FB-1} flowing into feedback node FB₁ from resistor R₁ exceeds a fixed value, LED short detector 22₁ determines that LED chain L₁ encounters an LED short event. If LED short detector 22₁ determines that LED chain L₁ encounters an LED short event, LED short detector 22₁ forced disables enable signal EN₁ through signal SH₁ and logic circuit 34₁, also disabling LED chain driver 24₁, and isolating minimum feedback voltage V_{FB-MIN} from feedback node FB₁. When short protection enable signal ENSH₁ is disabled, LED short detector 22₁ does not disable enable signal EN₁.

LED open circuit detector 32₁ detects whether LED chain L₁ encounters an LED open circuit event to provide corresponding protection mechanisms. For example, when LED chain L₁ encounters an open circuit event, feedback voltage V_{FB-1} and current sense voltage V_{CS-1} stay at roughly 0V, so that minimum feedback voltage V_{FB-MIN} at this time is also roughly 0V. However, in order to pull feedback voltage V_{FB-MIN} up to approximately 1V, pulse width controller 30 will continuously pull up output voltage V_{OUT} on output node OUT. Because LED chain L₁ encounters an open circuit event, pulled-up output voltage V_{OUT} has no effect on feedback voltage V_{FB-1}. Thus, output voltage V_{OUT} is pulled up continuously until an over voltage event occurs. Thus, in some embodiments, when backlight controller 20 discovers that voltage V_{OVP} on over-voltage protection node OVP exceeds an over-voltage preset value for over-voltage protection, and feedback voltage V_{FB-1} or current sense voltage V_{CS-1} is lower than 0.2V, backlight controller 20 determines that LED chain L₁ encounters an open circuit event. When LED open circuit detector 32₁ determines that LED chain L₁ encounters an LED open circuit event, LED open circuit detector 32₁ forced disables enable signal EN₁ through signal OP₁ and logic circuit 34₁, disabling LED chain driver 24₁, and isolating minimum feedback voltage V_{FB-MIN} from feedback node FB₁.

However, the LED open circuit event determination process may lead to mistaken determination of an LED short event of another LED chain. For example, assuming LED chain L₁ really encounters an open circuit, and LED chain L₂ is normal, output voltage V_{OUT} will be pulled up continuously, so that feedback voltage V_{FB-2} is also pulled up together. Having not yet reached an over-voltage event, LED short detector 22₂ may mistakenly determine that LED chain L₂ encounters an LED short event from information obtained from feedback node FB₂, resulting in mistaken disabling of LED chain driver 24₂.

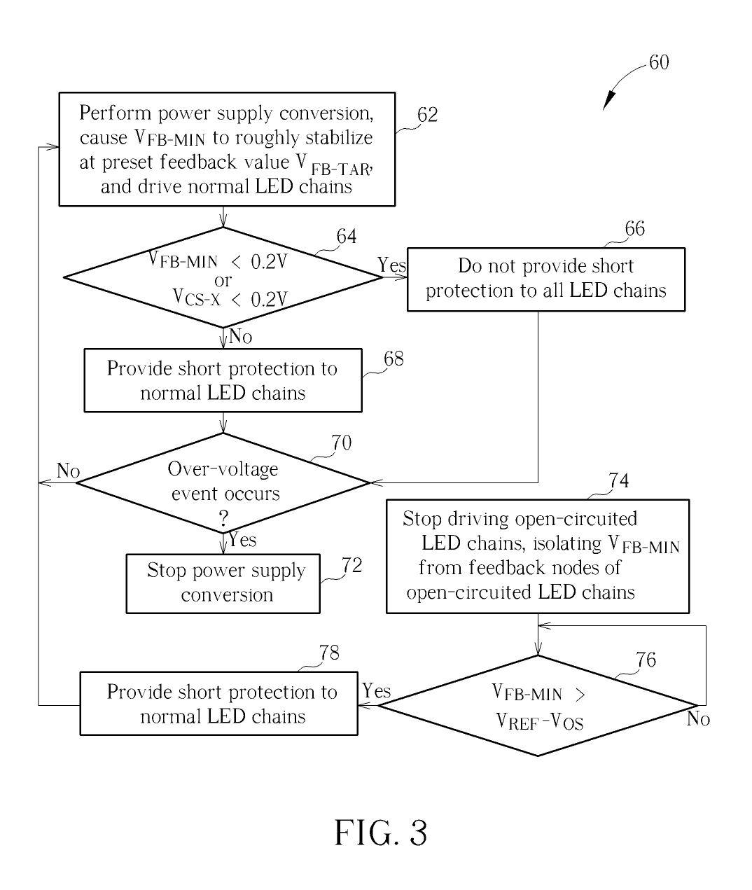

FIG. 3 is a diagram illustrating a control method 60 according to an embodiment. Please simultaneously refer to backlight controller 20 of FIG. 2. In the present disclosure, an open-circuit LED chain refers to an LED chain that is assumed to encounter an LED open event; a short-circuit LED chain refers to an LED chain that is assumed to encounter an LED short-circuit event; a normal LED chain refers to an LED chain that is assumed not to encounter an LED open or short-circuit event.

In step 62, backlight controller 20 senses a cathode of a normal LED chain through feedback nodes FB₁-FB_{N}, and controls power switch of booster 19 to regulate output voltage V_{OUT} of output node OUT, with the goal of causing minimum feedback voltage V_{FB-MIN} to be roughly stable at preset feedback value V_{FB-TAR}, e.g. 1V. Output voltage V_{OUT} of output node OUT is used for driving LED chain L₁-L_{N}.

Simultaneously, in step 62, backlight controller 20 controls driving current flowing through all normal LED chains. For example, in a startup process, backlight controller 20 initially assumes all LED chains L₁-L_{N} are normal LED chains, so that backlight controller 20 controls impedances of NMOS transistors N₁-N_{N} through gates G₁-G_{N}, equivalently controlling driving current through LED chains L₁-L_{N}.

In step 64, backlight controller 20 determines whether minimum feedback voltage V_{RB-MIN} current sense voltage V_{CS-X} corresponding to any normal LED chain L_{X} is too low. Here, X is an integer in a range of 1-N. For example, a voltage being too low means that the voltage is lower than a preset value, e.g. 0.2V. If minimum feedback voltage V_{FB-MIN} or current sense voltage V_{CS-X} is too low, this means an under-current event occurs (driving current of at least one LED chain is too low), and control method 60 enters step 66. In another embodiment, a condition for identifying LED chain L_{X} encounters an under-current event may be that current sense voltage V_{CS-X} is lower than a preset value, and gate voltage V_{G-X} on gate G_{X} is greater than another preset value. If no under-current event occurs, control method 60 enters step 68. Under-current events may occur for two different reasons: 1. output voltage V_{OUT} on output node OUT is not high enough to drive an LED chain, which generally occurs right after startup, or 2. an LED chain encounters an open-circuit event, so that minimum feedback voltage V_{FB-MIN} or current sense voltage V_{CS-X} is completely unable to be affected by output voltage V_{OUT}.

In step 66, backlight controller 20 disables all LED short detectors 22₁-22_{N} through short protection enable signals ENSH₁-ENSH_{N}. In other words, backlight controller 20 does not provide short protection to any of LED chains L₁-L_{N}.

In step 68, backlight controller 20 enables LED short detectors corresponding to normal LED chains through short protection enable signals ENSH₁-ENSH_{N}.

Step 70 comes after both of steps 66 and 68, where backlight controller 20 senses output voltage V_{OUT} on output node OUT through over-voltage protection node OVP to see whether an over-voltage event occurs. For example, when voltage V_{OVP} on over-voltage protection node OVP exceeds a preset over-voltage value, backlight controller 20 assumes an over-voltage event occurs. If an over-voltage event has not occurred, due to being unable to definitively identify an LED open-circuit event, the control method 60 returns to step 62, pulse width controller 30 operates normally, and normal LED chains are driven to emit light. If an over-voltage event occurs, backlight controller 20 determines that an LED open-circuit event occurs, and the control method 60 proceeds to step 72.

Please note that, under stable status in normal operation, backlight controller 20 operates following a loop formed by steps 62, 64, 68 and 70. Thus, an over-voltage event does not occur, and all normal LED chains enjoy short protection.

During a startup process, because voltage V_{OUT} of output node OUT is not high enough, backlight controller 20 may operate following a loop formed by steps 62, 64, 66 and 70 for a period of time. In other words, in the startup process, all LED chains do not have short protection. After startup is completed, and output voltage V_{OUT} is sufficiently high to cause under-current events to disappear, this loop is terminated, and the control method 60 enters the other loop used in stable status introduced above.

If only one LED encounters an open circuit, backlight controller 20 will also operate following the loop formed by steps 62, 64, 66 and 70 for a period of time. At this time, similarly, all LED chains do not have short protection. This can prevent erroneous determination that an LED short event occurs. When an over-voltage event is confirmed to have occurred, this loop is terminated, and the control method 60 enters step 72, and starts performing steps required for determining that an LED open-circuit event occurs.

In step 72, backlight controller 20 stops pulse width controller 30, and power switch of booster 19 is kept turned off, stopping transmission of energy to output node OUT, and output voltage V_{OUT} does not rise further. This can prevent output voltage V_{OUT} going too high, and damaging more fragile circuit components. The control method 60 then performs step 74.

If the under-current event of step 64 and the over-voltage event of step 70 both occur, then it is roughly certain which LED chain encounters an LED open-circuit event. For example, if it is discovered that driving current of LED chain L_{O} is too low in step 64, then after encountering an over-voltage event in step 74, it is roughly certain that LED chain L_{O} is an open-circuit LED chain. In step 74, backlight controller 20 causes open-circuit LED chain not to be driven, and minimum feedback voltage V_{FB-MIN} not to be affected by the open LED chain. For example, if LED chain L₁ is an open-circuit LED chain discovered by LED open-circuit detector 32₁, LED open-circuit detector 32₁ both disables LED chain driver 24₁ and also causes minimum voltage selector 26 to isolate minimum feedback voltage V_{FB-MIN} from feedback node FB₁ through signal OP₁ and enable signal EN₁. And, at this time, all LED chains do not have short protection.

At this time, remaining normal LED chains are lit as usual by driving of the corresponding LED chain drivers. Thus, energy stored at output node OUT is gradually consumed, and output voltage V_{OUT} starts to drop.

Step 76 detects whether voltage V_{OUT} of output node OUT is restored to a safe level with normal LED chain lighting. In some embodiments, this safe level represents that voltage V_{OVP} has already dropped to lower than 80% of the preset over-voltage value described above. In other embodiments, this safe level represents that minimum feedback voltage V_{FB-MIN} has already dropped to lower than the preset feedback level described above. Step 76 continuously performs checking, and the control method 60 enters step 78 only once output voltage V_{OUT} of output node OUT is restored to the safe level.

In step 78, backlight controller 20 provides short protection to normal LED chains through short protection enable signals ENSH₁-ENSH_{N}. Because short-circuit or open-circuit LED chains are not driven, short protection need be provided thereto.

Control method 60 then performs step 62. At this time, minimum feedback voltage V_{FB-MIN} is only affected by normal LED chain feedback nodes, and is not affected by short-circuit or open-circuit LED chain feedback nodes. In other words, short-circuit or open-circuit LED chains do not affect regulation of minimum feedback voltage V_{FB-MIN} or voltage V_{OUT}. Thus, backlight controller 20 can operate normally.

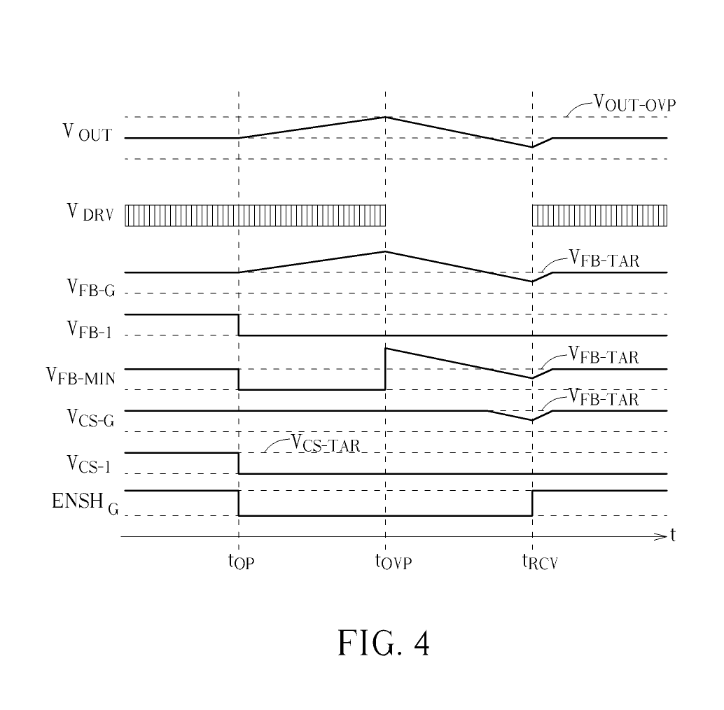

FIG. 4 illustrates waveforms of signals of FIG. 2 during operation of control method 60 of FIG. 3. In FIG. 4, it is assumed that LED chain L₁ becomes open-circuited at time t_{OP}, and LED chain L_{G} is a normal LED chain. In FIG. 4, shown from top to bottom are output voltage V_{OUT} of output node OUT, driving signal V_{DRV} of driving node DRV, feedback voltage V_{FB-G} corresponding to normal LED chain L_{G}, feedback voltage V_{FB-1} corresponding to LED chain L₁, minimum feedback voltage V_{FB-MIN}, current sense voltage V_{CS-G} corresponding to normal LED chain L_{G}, current sense voltage V_{CS-1} corresponding to LED chain L₁, and short protection enable signal ENSH_{G} corresponding to normal LED chain L_{G}.

Prior to time t_{OP}, it is assumed that all LED chains L₁-L_{N} are the same and are normal. At this time, driving signal V_{DRV} switches periodically, performing power supply switching, and output voltage V_{OUT} is roughly at a value. This value causes feedback voltage V_{FB-1}, feedback voltage V_{FB-G} and minimum feedback voltage V_{FB-MIN} to stabilize at approximately preset feedback value V_{FB-TAR}. Current sense voltages V_{CS-G} and V_{CS-1} are also stabilized at preset value V_{CS-TAR}, showing that driving currents flowing through LED chains L_{G} and L₁ are approximately equal and normal.

At time t_{OP}, LED chain L₁ becomes open-circuited. Because driving current disappears suddenly, current sense voltage V_{CS-1} and feedback voltage V_{FB-1} rapidly become 0V, causing minimum feedback voltage V_{FB-MIN} to drop to 0V in turn. As disclosed for step 66 of FIG. 3, after detecting that minimum feedback voltage V_{FB-MIN} or current sense voltage V_{CS-1} is too low, all LED chains L₁-L_{N} are not provided short protection, thus short protection enable signal ENSH_{G} changes state from enabled to disabled.

After time t_{OP}, in order to pull up minimum feedback voltage V_{FB-MIN}, backlight controller 20 increases its energy conversion, so that voltage V_{OUT} gradually increases. Feedback voltage V_{FB-G} increases with increasing output voltage V_{OUT}. However, because LED chain L₁ becomes open-circuited, pulled-up voltage V_{OUT} has no effect on feedback voltage V_{FB-1}, so that feedback voltage V_{FB-1} and minimum feedback voltage V_{FB-MIN} stay continually at 0V.

At time t_{OVP}, backlight controller 20 discovers that output voltage V_{OUT} exceeds preset over-voltage value V_{OUT-OVP} through detection of over-voltage protection node OVP, confirming that an over-voltage event occurs. As taught by step 72 of FIG. 3, driving signal V_{DRV} becomes fixed at 0V, and energy conversion is stopped, so that output voltage V_{OUT} does not rise further. At this time, relatively low feedback voltage V_{FB-1} can cause backlight controller 20 to confirm that LED chain L₁ encounters an open-circuit event, so that backlight controller 20 stops driving LED chain L₁, and minimum feedback voltage V_{FB-MIN} and feedback voltage V_{FB-1} are mutually isolated. Thus, minimum feedback voltage V_{FB-MIN} immediately starts reflecting feedback voltage V_{FB-G}.

After time t_{OVP}, LED chain L_{G} is lit as usual, so that current sense voltage V_{CS-G} is roughly stabilized at preset value V_{CS-TAR}. With energy consumption of LED chain L_{G}, voltage V_{OUT} falls, causing feedback voltage V_{FB-G} and minimum feedback voltage V_{FB-MIN} to fall together.

At time t_{RCV}, backlight controller 20 discovers that voltage V_{OVP} or minimum feedback voltage V_{FB-MIN} has already reached a safe level, and thus causes short protection enable signal ENSH_{G} to change state to enabled, and begin providing short protection to normal LED chains, as taught by step 78 of FIG. 3. Simultaneously, driving signal V_{DRV} returns to periodic switching, and starts converting energy. Thus, after a period of time, feedback voltage V_{FB-G} and minimum feedback voltage V_{FB-MIN} roughly stabilize again to preset feedback value V_{FB-TAR}.

From FIG. 4 and FIG. 3, it can be seen that, from time t_{OP}to time t_{RCV}, short protection of all LED chains L₁-L_{N} is disabled. Thus, no mistaken determination of short-circuit events occurs. And, in the embodiments of the present disclosure, only after voltage V_{OVP} or minimum feedback voltage V_{FB-MIN} reaches the safe level will normal LED chain short protection be enabled, which can prevent premature activation of short protection, which would lead to erroneous determination of a short-circuit event.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method for driving light emission of a plurality of light-emitting diode (LED) chains, the control method comprising:
detecting the LED chains to regulate an output power, wherein the output power is used for driving the LED chains;
controlling a plurality of driving currents flowing respectively through the LED chains;
detecting whether at least one of the driving currents encounters an under-current event, wherein an open-circuited LED chain is an LED chain encountering the under-current event, and a normal LED chain is an LED chain not encountering the under-current event;
stopping short protections applied to the LED chains when the under-current event is encountered;
detecting whether the output power encounters an over-voltage event;
stopping regulating of the output power when the over-voltage event is encountered;
detecting whether the output power returns to a safe level; and
resuming regulation of the output power and resuming the short protections applied to the normal LED chain after the output power returns to the safe level.

2. The control method of claim 1, further comprising:
causing the open-circuited LED chain to not affect regulation of the output power when the over-voltage event is encountered.

3. The control method of claim 1, wherein the LED chains have a plurality of feedback terminals, and the step of regulating the output power is performed according to a minimum feedback voltage of the feedback terminals.

4. The control method of claim 3, wherein at least one of the driving currents has encountered the under-current event when the minimum feedback voltage is lower than a predetermined value.

5. The control method of claim 3, wherein:
the over-voltage event is encountered when an output voltage of the output power exceeds a predetermined over-voltage value; and
the output power returns to the safe level when the minimum feedback voltage is lower than a predetermined safe value.

6. The control method of claim 1, further comprising:
isolating the minimum feedback voltage from a feedback terminal corresponding to the open-circuited LED chain when the over-voltage event is encountered.

7. The control method of claim 1, further comprising:
detecting whether one of the driving currents encounters an under-current event from a plurality of current detection terminals;
wherein each current detection terminal connects to one corresponding current detection resistor.

8. The control method of claim 1, wherein the LED chains have a plurality of feedback terminals, and the short protection is triggered according to a feedback voltage corresponding to an LED chain under protection.

9. The control method of claim 1, wherein:
the over-voltage event is encountered when an output voltage of the output power exceeds a predetermined over-voltage value; and
the output power returns to the safe level when the output voltage is lower than a predetermined safe value.

10. The control method of claim 1, further comprising:
controlling a switched-mode power supply to regulate the output power according to the LED chains.

11. The control method of claim 1, further comprising:
controlling the driving currents to make each of the driving currents roughly greater than a predetermined current value.

12. A control method for driving light emission of a plurality of LED chains, the control method comprising:
driving the LED chains by an output power;
providing short protection corresponding to each of the LED chains;
detecting whether the LED chains encounter an under-current event;
stopping the short protections of all of the LED chains if any one of the LED chains encounters the under-current event;
detecting whether the output power reaches a safe level; and
resuming short protection corresponding to a normal LED chain after the output power reaches the safe level;
wherein the normal LED chain has not encountered the under-current event.

13. The control method of claim 12, further comprising:
regulating the output power;
detecting whether the output power encounters an over-voltage event;
stopping regulation of the output power when the over-voltage event is encountered; and
resuming regulation of the output power after the output power reaches the safe level.
